(19) United States
(12) Patent Application Publication
(10) Pub. No.: US 2026/0235981 A1
(43) Pub. Date: Aug. 13, 2026

(54) IMAGE HEATING APPARATUSES

(71) Applicant: CANON KABUSHIKI KAISHA, Tokyo (JP)

(72) Inventor: HIROSHI KATAOKA, Shizuoka (JP)

(21) Appl. No.: 19/537,259

(22) Filed: Feb. 11, 2026

(30) Foreign Application Priority Data
Feb. 13, 2025 (JP) 2025-021654

(51) Int. Cl. G03G 15/20

(52) U.S. Cl. CPC G03G 15/2053; G03G 15/2017; G03G 15/2028; G03G 15/2042; G03G 15/2057

(57) ABSTRACT

Image heating apparatuses are provided herein. An image heating apparatus includes: a film; a heater; a roller; and a regulating member which includes a plurality of first regulating portions arrayed along a direction of the film on an upstream side in the conveying direction with respect to the nip portion, the regulating member further including a second regulating portion arranged between the plurality of first regulating portions in the direction of the generatrix. In the conveying direction, an upstream end of the second regulating portion is positioned on a downstream side of an upstream end of the first regulating portions. In a direction orthogonal to the conveying direction and to the direction of the generatrix, a distance from the nip portion to a distal end of the second regulating portion is longer than a distance from the nip portion to an upstream end of the film in the conveying direction.

### BACKGROUND

### Field of the Technology

The present disclosure relates to one or more embodiments of image heating apparatuses.

### Description of the Related Art

Image heating apparatuses adopting a film heating system featuring superior energy efficiency and rapid transition to a fixable state are known as image heating apparatuses used in electrophotographic image forming apparatuses. Image heating apparatuses adopting a film heating system are constituted of a rotatable film, a heater that comes into contact with the film and heats the film, a roller that abuts against an outer circumferential surface of the film and forms a nip portion, and the like. A recording material bearing an unfixed toner image is heated while being sandwiched and conveyed by the nip portion, thereby fixing the toner image on the recording material onto the recording material.

As an image heating apparatus adopting a film heating system, a configuration is known in which a regulating member (guiding member) that guides rotation of the film while regulating a rotational shape of the film is provided in an internal space of the film. For example, Japanese Patent Application Laid-open No. 2004-281286 discloses a regulating member provided with a guide rib that regulates a rotational shape of a film. In addition, Japanese Patent No. 2949926 discloses a regulating member having a semicircular outer surface extending in the direction of the generatrix of the film.

When a contact area of the regulating member to the film is excessively large, heat from the film is transferred to the regulating member, undesirably increasing a frictional resistance acting on the film. On the other hand, in configurations where the regulating member comes into partial contact with the film in the direction of the generatrix of the film, there is a risk that the film may deform or break due to thermal non-uniformity in the direction of the generatrix of the film.

### SUMMARY

One or more aspects of the present disclosure is directed to providing one or more embodiments of image heating apparatuses that suppress film deformation.

According to at least one aspect of the present disclosure, one or more embodiments of an image heating apparatus may be configured to heat an image formed on a recording material while conveying the recording material with a nip portion, where the image heating apparatus may include: a rotatable cylindrical film; a heater configured to heat the rotatable cylindrical film, the heater being arranged in an internal space of the rotatable cylindrical film; a roller which comes into contact with an outer circumferential surface of the rotatable cylindrical film and which forms the nip portion for conveying the recording material in a conveying direction between the roller and the rotatable cylindrical film; and a regulating member which is arranged in the internal space of the rotatable cylindrical film and configured to regulate a rotational shape of the rotatable cylindrical film, the regulating member including a plurality of first regulating portions arrayed along a direction of a generatrix of the rotatable cylindrical film on an upstream side in the conveying direction with respect to the nip portion and a second regulating portion arranged between the plurality of first regulating portions in the direction of the generatrix of the rotatable cylindrical film, wherein in the conveying direction, an upstream end of the second regulating portion is positioned on a downstream side of an upstream end of the first regulating portions, and in a direction orthogonal to the conveying direction and to the direction of the generatrix of the rotatable cylindrical film, a distance from the nip portion to a distal end of the second regulating portion is longer than a distance from the nip portion to an upstream end of the rotatable cylindrical film in the conveying direction. According to another aspect of the present disclosure, one or more embodiments of an image heating apparatus may be configured to heat an image formed on a recording material while conveying the recording material with a nip portion, where the image heating apparatus may include: a rotatable cylindrical film; a heater configured to heat the rotatable cylindrical film, the heater being arranged in an internal space of the rotatable cylindrical film; a roller which comes into contact with an outer circumferential surface of the rotatable cylindrical film and which forms a nip portion for conveying the recording material in a conveying direction between the roller and the rotatable cylindrical film; and a regulating member which is arranged in the internal space of the rotatable cylindrical film and configured to regulate a rotational shape of the rotatable cylindrical film, the regulating member including a plurality of first regulating portions arrayed along a direction of the generatrix of the rotatable cylindrical film on an upstream side in the conveying direction with respect to the nip portion and a second regulating portion extending along the direction of the generatrix of the rotatable cylindrical film from one of the first regulating portions to an adjacent first regulating portion among the plurality of first regulating portions, wherein in a direction orthogonal to the conveying direction and to the direction of the generatrix of the rotatable cylindrical film, the second regulating portion is provided at a same position as an upstream end of the rotatable cylindrical film in the conveying direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of at least one embodiment of an image forming apparatus according to one or more aspects of the present disclosure.

FIG. 2 is a schematic sectional view of at least one embodiment of an image heating apparatus according to one or more aspects of the present disclosure.

FIG. 3 is an explanatory diagram of a configuration of at least one embodiment of an image heating apparatus according to one or more aspects of the present disclosure.

FIGS. 4A to 4C are diagrams showing at least one embodiment having a deformation of a fixing film according to one or more aspects of the present disclosure.

FIGS. 5A to 5C are explanatory diagrams and graphs illustrating at least one embodiment having a buckling deformation of a fixing film according to one or more aspects of the present disclosure.

FIGS. 6A and 6B are diagrams showing at least one embodiment example of a fixing film having undergone buckling deformation according to one or more aspects of the present disclosure.

FIG. 7 is an explanatory diagram of at least one embodiment example of an origin of buckling deformation of a fixing film according to one or more aspects of the present disclosure.

FIGS. 8A to 8D are explanatory diagrams of at least two embodiments of film guides according to one or more aspects of the present disclosure.

FIGS. 9A and 9B are explanatory diagrams of one or more embodiments of film guides according to modifications according to one or more aspects of the present disclosure.

FIGS. 10A to 10E are explanatory diagrams of at least one embodiment of a film guide according to one or more aspects of the present disclosure.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments. In addition, not all features described in the following embodiments are essential to solutions provided by the disclosure.

### Configurations of One or More Embodiments

At least one embodiment example of applying one or more features of the present disclosure to an electrophotographic laser beam printer will be described herein. An image forming apparatus 1 according to one or more embodiments receives a print signal that is image information transmitted from an external apparatus such as a personal computer (not illustrated) and forms the signal information as an image on a recording material P using image formation of an electrophotographic system.

### 1. Configuration(s) of One or More Embodiments of an Image Forming Apparatus

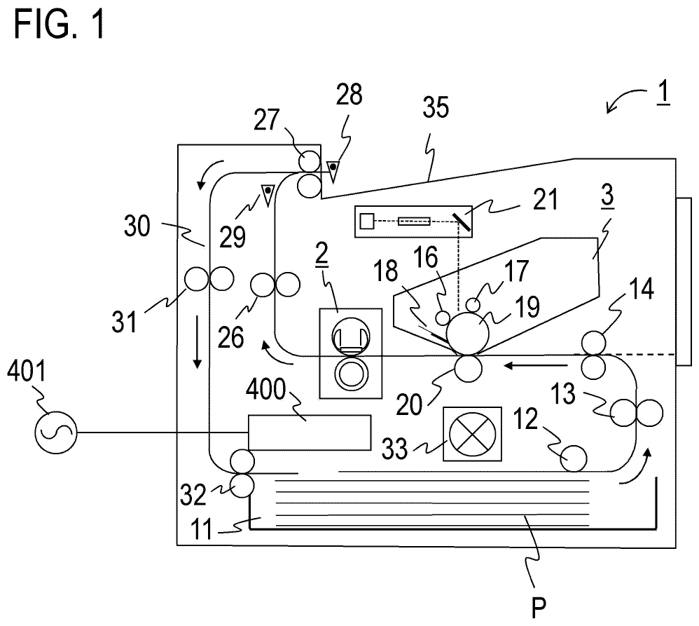

FIG. 1 is a schematic sectional view of an image forming apparatus 1 according to one or more embodiments of the present disclosure. An external apparatus and the image forming apparatus 1 are connected to each other via a control portion 400 in the image forming apparatus 1. In a case where the control portion 400 receives a print signal from the external apparatus, the image forming apparatus 1 executes an image forming operation.

An image forming operation of the image forming apparatus 1 will now be described. First, in a case where laser light modulated in accordance with image information is emitted from a scanner unit 21, a surface of a photosensitive drum 19 charged to a potential of a prescribed polarity by a charging roller 16 is scanned. Accordingly, an electrostatic latent image is formed on the photosensitive drum 19. In a case where the electrostatic latent image is supplied with toner from a developing roller 17, the electrostatic latent image on the photosensitive drum 19 is developed as a toner image as a visible image.

Recording material P stored in a paper feeding cassette 11 is fed one by one by a paper feeding roller 12 and conveyed toward a registration roller pair 14 by a conveying roller pair 13. Arrows in FIG. 1 indicate a conveying direction of the recording material P. The recording material P is conveyed in synchronization with the arrival of the toner image on the photosensitive drum 19 at a transfer nip formed by the photosensitive drum 19 and a transfer roller 20 from the registration roller pair 14 to the transfer nip. The toner image on the photosensitive drum 19 is transferred to the recording material P as the recording material P passes through the transfer nip. The series of operations described thus far are performed by an image forming portion of the image forming apparatus 1. Toner remaining on the photosensitive drum 19 without being transferred to the recording material P at the transfer nip is scraped off the photosensitive drum 19 by a drum cleaner 18 in preparation for a next image formation.

Subsequently, the recording material P is heated and pressurized by an image heating apparatus 2 as a fixing apparatus (fixing portion) and the toner image is fixed by heat to the recording material P. A heating source of the image heating apparatus 2 is controlled by the control portion 400 so as to maintain a temperature necessary for fixing an unfixed toner image onto the recording material P. The recording material P bearing the fixed toner image is discharged to a paper discharge tray 35 in an upper part of the image forming apparatus 1 by a conveying roller pair 26 and a paper discharge roller pair 27. Discharge of the recording material P on which printing has been completed to outside of the image forming apparatus 1 is detected by a paper discharge detection sensor 28 that is a detection means or a detection structure provided in a vicinity of the paper discharge roller pair 27. The image formation sequence ends in a case where the paper discharge detection sensor 28 detects the discharge of the recording material P. In addition, the paper discharge detection sensor 28 may also be equipped with a function of detecting a case where the number of sheets of the recording material P stacked in the paper discharge tray 35 is equal to or below a prescribed stack limit.

A process cartridge 3 is attachably/detachably mounted to/from an apparatus main body of the image forming apparatus 1. The process cartridge 3 may include or is constituted of the developing roller 17, a developing unit or developer (or developing structure) storing the photosensitive drum 19 and toner, the charging roller 16, and a cleaning unit or cleaner (or cleaning structure) including the drum cleaner 18. In addition, the image forming apparatus 1 is provided with a motor 33 that drives the image forming apparatus 1, the image heating apparatus 2, the process cartridge 3, and the like.

A maximum paper-passing width of the image forming apparatus 1 according to one or more embodiments that is a width in a direction orthogonal to the conveying direction of the recording material P is 216 mm [LTR size]. By conveying the recording material P at a conveyance speed of 233 mm/sec, the image forming apparatus 1 is capable of printing of 42 sheets per minute for LTR size and 40 sheets per minute for A4 size [210 mm×297 mm]. In addition, the image forming apparatus 1 is capable of forming images on both sides of the recording material P (referred to as duplex printing).

Duplex printing is executed in the following sequence. The recording material P with an initial toner image formed on a first side thereof passes through the image heating apparatus 2, and after a trailing end of the recording material P passes a position of a flapper 29 for switching conveyance paths, the position of the flapper 29 changes to a duplex conveyance side.

Simultaneously with the switching of the flapper 29, a rotation direction of the paper discharge roller pair 27 is reversed by a reversing clutch (not illustrated) that determines the rotation direction of the paper discharge roller pair 27. The recording material P is drawn into the image forming apparatus 1 by the paper discharge roller pair 27 that rotates in reverse and is conveyed to a duplex conveying path 30. The recording material P, of which a second side has been reversed so as to serve as an image-forming side, is conveyed once more by a duplex conveying roller pair 31 and a main body paper re-feeding roller pair 32 in the duplex conveying path 30 to the conveying roller pair 13 and the registration roller pair 14. In addition, a toner image is formed on the opposite side from the side on which an image has been formed of the recording material P having passed through the duplex conveying path 30.

Steps from the registration roller pair 14 onward are the same as the image formation described earlier. Specifically, a toner image is formed on the second side of the recording material P, and after the recording material P once again passes through the image heating apparatus 2, the recording material P is discharged to outside of the image forming apparatus 1 by the paper discharge roller pair 27 and stacked so that the second side faces the side of the paper discharge tray 35. Demand for duplex printing has been increasing in recent years alongside growing environmental awareness.

### 2. Configuration(s) of One or More Embodiments of an Image Heating Apparatus

A configuration of the image heating apparatus 2 according to one or more embodiments will be described. The image heating apparatus 2 heats an image formed on the recording material P while conveying the recording material in a conveying direction D1 with a fixing nip N as a nip portion. In the following description, an X-direction is defined as a direction parallel to the conveying direction of the recording material P in the image heating apparatus 2, a Y-direction is defined as a direction parallel to the direction of the generatrix or a rotational axis of a fixing film 202 in the image heating apparatus 2, and a Z-direction is defined as a direction perpendicular to the planar fixing nip N. The X-direction, the Y-direction, and the Z-direction intersect each other (orthogonally in one or more embodiments).

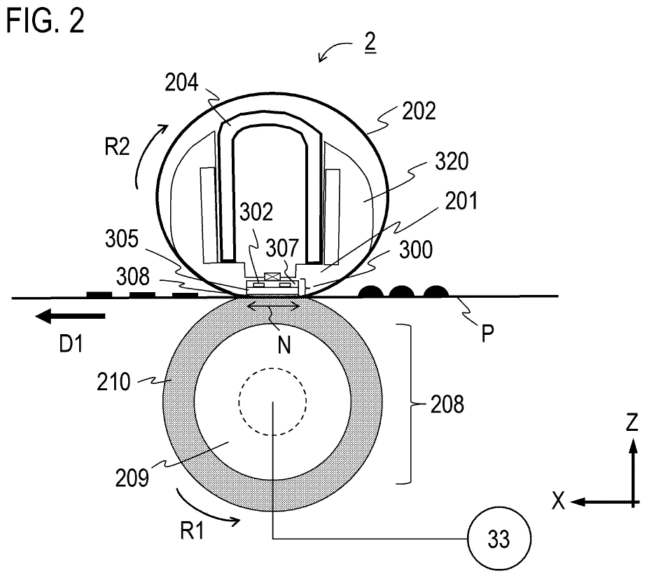

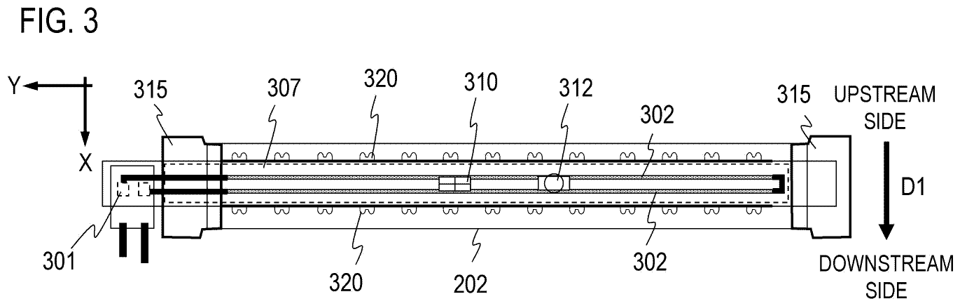

FIG. 2 is a schematic sectional view of the image heating apparatus 2 according to one or more embodiments and is a diagram of the image heating apparatus 2 in a case where viewed in the Y-direction. FIG. 3 is an explanatory diagram of at least one embodiment of a configuration of the image heating apparatus 2 according to one or more aspects of the present disclosure and is a diagram of the image heating apparatus 2 in a case where viewed in the Z-direction. In FIG. 3, in order to show an arrangement relationship in a longitudinal direction of the fixing film 202 and a heater 300 constituting or forming the image heating apparatus 2, some members of the fixing film 202 and the like are shown as transparent while depiction of other members has been omitted.

The image heating apparatus 2 includes the rotatable fixing film 202 as an endless belt, the heater 300 that heats the fixing film 202, and a pressure roller 208 which forms the fixing nip N together with the heater 300 via the fixing film 202. Furthermore, the image heating apparatus 2 includes the film guide 201 which holds the heater 300 and guides the rotation of the fixing film 202 and a metal stay 204 that holds both end portions of the fixing film 202. The heater 300, the film guide 201, and the metal stay 204 are arranged in an internal space of the fixing film 202.

The fixing film 202 is a thin-walled, cylindrically formed, highly heat-resistant film with a multi-layer structure and is formed of a heat-resistant resin or metal. A direction of the generatrix (longitudinal direction) of the fixing film 202 is parallel to the Y-direction, and the fixing film 202 is configured to be rotatable around a rotational axis parallel to the Y-direction.

A base layer of the fixing film 202 is made of a heat-resistant resin such as polyimide or a metal such as stainless steel. In addition, a surface of the fixing film 202 is provided with a releasing layer formed of a high-function fluorine resin with superior heat resistance and releasability of PFA and the like for preventing adhesion of toner. Furthermore, in order to improve image quality, highly heat-resistant rubber such as silicone rubber may be formed as an elastic layer between the base layer and the releasing layer. In one or more embodiments, a film with an outer diameter of 24 mm and including an elastic layer is used as the fixing film 202.

The pressure roller 208 is a roller including a core metal 209 made of a material such as iron or aluminum and an elastic layer 210 made of a highly heat-resistant rubber material such as silicone rubber. Such a configuration provides the pressure roller 208 with appropriate hardness as a pressing member and enables the fixing nip N in accordance with the image heating apparatus 2 to be obtained. In tone or more embodiments, a roller with an outer diameter of 25 mm and including a 4 mm-thick elastic layer is used as the pressure roller 208.

The pressure roller 208 rotates in a direction of an arrow R1 (counterclockwise direction in FIG. 2) due to a rotational driving force received from the motor 33. Due to the rotation of the pressure roller 208, the fixing film 202 rotates in a direction of an arrow R2 (clockwise direction in FIG. 2) so as to follow the rotation of the pressure roller 208. A direction of the generatrix (longitudinal direction) of the pressure roller 208 is parallel to the Y-direction and the pressure roller 208 is configured to be rotatable around a rotational axis parallel to the Y-direction.

The heater 300 is a heating source that comes into contact with an inner circumferential surface of the fixing film 202, generates heat, and heats the fixing film 202. A base material of the heater 300 is ceramic and a longitudinal direction of the heater 300 is the Y-direction. In one or more embodiments, a ceramic substrate 305 made of alumina or the like with high electrical insulation, excellent thermal conductivity, and low heat capacity is used in the heater 300. The ceramic substrate 305 used in one or more embodiments contains alumina (Al₂O₃) as the base material.

An electrically-conductive heating resistive layer 302 made of silver-palladium or the like is formed by screen printing or the like along the longitudinal direction of the heater 300 (ceramic substrate 305) on a surface of the ceramic substrate 305 that faces away from the fixing nip N. Furthermore, the electrically-conductive heating resistive layer 302 is covered by a thin protective glass layer 307 with a thickness of around 50 μm to ensure insulation properties of the electrically-conductive heating resistive layer 302.

A sliding glass layer 308 with a thickness of around 10 μm thick is formed on a surface of the ceramic substrate 305 that faces the side of the fixing nip N to ensure sliding properties with respect to the fixing film 202. The sliding glass layer 308 is coated with a fluorine-based grease (not illustrated) with excellent heat resistance in order to enhance sliding properties with respect to the fixing film 202. In other words, the sliding glass layer 308 constitutes an abutting surface of the heater 300 with respect to the fixing film 202.

The electrically-conductive heating resistive layer 302 generates heat in a case where AC power is supplied from a heater electrode 301 provided at a longitudinal end portion of the heater 300. The generation of heat by the electrically-conductive heating resistive layer 302 causes the entire heater 300 including the ceramic substrate 305, the protective glass layer 307, and the sliding glass layer 308 to rapidly heat up.

The temperature rise of the heater 300 is detected by a thermistor 310 that is a temperature-sensing element positioned on a rear surface of the heater 300 (a side facing the protective glass layer 307) and fed back to the control portion 400 (control circuit). Power supplied to the electrically-conductive heating resistive layer 302 is controlled so that the temperature of the heater 300 that is sensed by the thermistor 310 is maintained at a prescribed fixation temperature.

In addition, the heater 300 is provided with a safety element 312 that activates due to abnormal heating of the heater 300 and cuts off the power supplied to the electrically-conductive heating resistive layer 302. The safety element 312 is, for example, a thermoswitch or a thermal fuse, and is arranged either directly on the heater 300 or with a gap between the safety element 312 and the heater 300.

The heater 300 is held by the film guide 201 that is a heater holding member made of heat-resistant resin. By heating the fixing film 202, the heater 300 heats the recording material P sandwiched between the fixing film 202 and the pressure roller 208 at the fixing nip N.

The film guide 201 is a regulating member which is arranged in the internal space of the fixing film 202 and which guides the rotation of the fixing film 202 while regulating a rotational shape of the fixing film 202. Here, the rotational shape of the fixing film 202 is a shape of the fixing film 202 in a case where the fixing film 202 rotates so as to follow the rotation of the pressure roller 208. Since the fixing film 202 is subjected to various external forces during rotation of the fixing film 202, the fixing film 202 rotates in a deformed shape as compared to when the fixing film 202 is stationary. The film guide 201 is configured to abut against the fixing film 202 and regulate the rotational shape of the fixing film 202 in order to suppress excessive deformation of the fixing film 202. In one or more embodiments, the film guide 201 is a member of which the longitudinal direction is the Y-direction.

The film guide 201 includes a plurality of guide ribs 320 as regulating portions that regulate the rotational shape of the fixing film 202. The plurality of guide ribs 320 are provided on an upstream side and a downstream side in the conveying direction D1 with respect to the fixing nip N, respectively, and are arrayed along the direction of the generatrix of the fixing film 202 (Y-direction). In addition, a flange 315 is fixed to the film guide 201 as a film holding member that is a member for holding both end portions of the fixing film 202.

In order to guide the rotation of the fixing film 202 along an inner surface of the fixing film 202, the guide ribs 320 are formed in a smooth, semicircular curved shape that follows a rotational trajectory of the fixing film 202. In the conveying direction D1, the guide ribs 320 on the upstream side of the fixing nip N protrude toward the upstream side and the guide ribs 320 on the downstream side of the fixing nip N protrude toward the downstream side. In other words, the guide ribs 320 are protruded portions that protrude toward upstream and downstream sides in the conveying direction D1 from the fixing nip N. The smooth semicircular shape and the amount of protrusion are not limited to what is illustrated and may be optimally configured according to one or more specifications that may be used for the image forming apparatus 1 and the image heating apparatus 2.

The guide ribs 320 prevent the fixing film 202 from coming into contact with the film guide 201 and the metal stay 204 over large areas, thereby reducing the contact areas. In addition, even in a case where the fixing film 202 comes into contact with the guide rib 320, the small contact areas suppress frictional resistance and enable smooth and stable driven rotation.

The metal stay 204 receives a pressurizing force (not illustrated) and presses the film guide 201 toward the pressure roller 208. An unfixed toner image on the recording material P is subjected to fixing processing by receiving heat from the heater 300 via the fixing film 202 while sandwiching and conveying the recording material P at the fixing nip N.

### 3. Buckling Deformation of One or More Embodiments of a Fixing Film

Next, the buckling deformation of the fixing film 202 that may be used for one or more embodiments will be described. Films such as the fixing film 202 used in the film heating system are formed thinly using high-performance resins or metals in order to reduce thermal mass, achieve energy efficiency, and enable rapid transition to a fixable state, which may result in buckling deformation.

The fixing film 202 is supported at both longitudinal end portions by the flange 315 and is sandwiched along substantially its entire longitudinal length by the heater 300 and the pressure roller 208 so as to form the fixing nip N. A specific example of buckling deformation occurring in a longitudinal center portion of the fixing film 202 in this state will be described below.

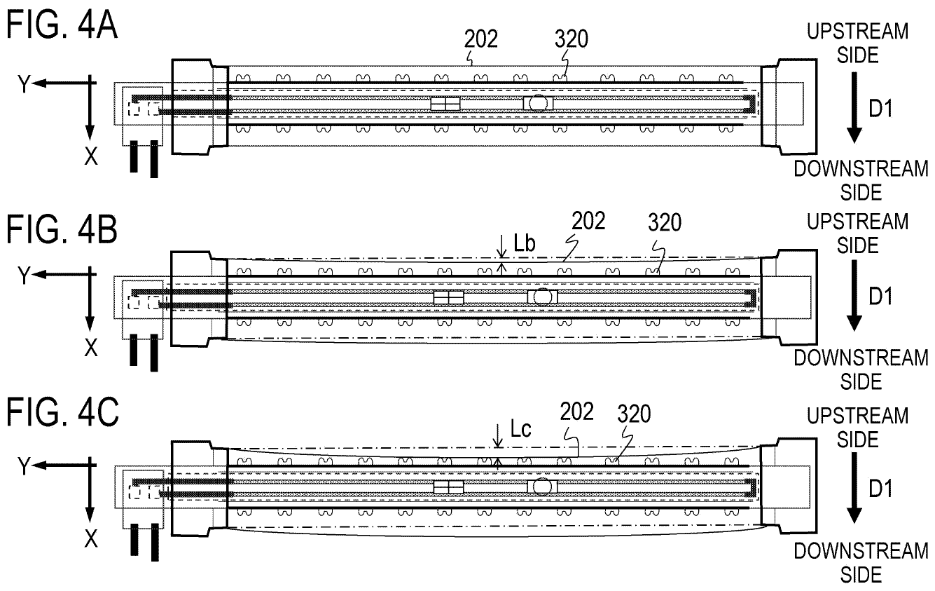

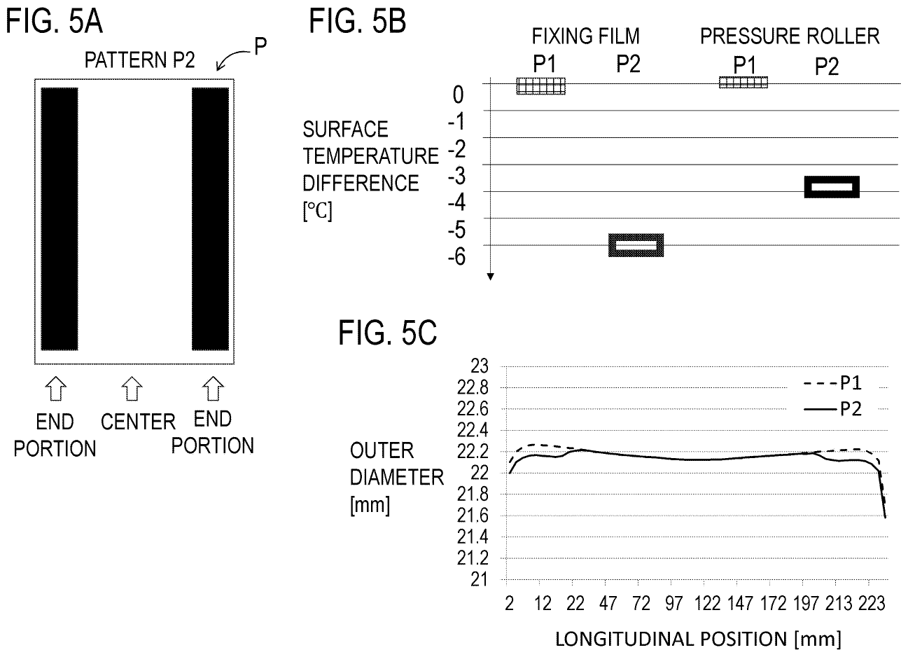

Hereinafter, a state of the fixing film 202 during a rotational operation and a reason why buckling deformation occurs will be described. FIGS. 4A to 4C are diagrams showing how the fixing film 202 deforms. FIGS. 5A to 5C are explanatory diagrams of the buckling deformation of the fixing film 202.

In an image heating apparatus 200 adopting a film heating system according to one or more embodiments, the pressure roller 208 is rotationally driven to convey the recording material P and the fixing film 202 is configured to be driven to rotate so as to follow the pressure roller 208 and the conveyed recording material P. In such an image heating apparatus 200, in order to prevent wrinkling as a deformation phenomenon of the printed recording material P, stable conveyance of the recording material P is achieved by applying a predetermined conveying force to the recording material P as it passes through the fixing nip N.

Wrinkles may occur due to forces acting from an end portion toward a central portion of the recording material P in the width direction (orthogonal to the conveying direction D1) as the recording material P passes through the fixing nip N. In a case where the recording material P gathers toward the center and passes through the fixing nip N in this gathered state, deformation occurs on the recording material P in the form of wrinkles. In this manner, wrinkles are a phenomenon that tends to occur in the central portion where the material is gathered. Even in a case where wrinkles do not form, the conveyance of the recording material P that passes through the fixing nip N may become unstable, and a distortion of the toner image may occur in a case where the unfixed toner image comes into contact with the fixing film 202 before the fixing nip N. Such a deformation may be avoided by subjecting the recording material P to a conveying force in a direction of pulling the recording material P from the central portion toward the end portion of the recording material P to stabilize the conveyance of the recording material P as it passes through the fixing nip N.

As a specific measure, the conveying force described above may be produced by adopting a shape of the width of the fixing nip N in the conveying direction D1 such that both end portions are equal to or wider than the central portion in the longitudinal direction of the fixing nip N. One example of means or structure therefor is to make the outer diameter of the pressure roller 208 thicker in the end portions than in the central portion in the longitudinal direction and to make a peripheral speed of the pressure roller 208 in the end portions higher than in the central portion. Creating a conveying force that conveys the end portions of the recording material P faster than the central portion of the recording material P causes a force to be applied in a direction of pulling the recording material P from the central portion toward the end portion of the recording material P, realizing stable conveyance of the recording material P. The fixing film 202 receives a force in the conveying direction D1 from the recording material P that is conveyed while being subjected to such a conveying force.

On the other hand, both end portions of the fixing film 202 are supported by the flange 315. The fixing film 202 during a rotational operation is driven by these forces to be deflected toward the downstream side along the conveying direction of the recording material P with a portion being supported by the flange 315 as an origin while rotating in a driven manner. FIGS. 4A to 4C show a state of the fixing film 202 as viewed from above in the Z direction of the image heating apparatus 2. In FIGS. 4A to 4C, in order to show an arrangement relationship in a longitudinal direction of the fixing film 202 and the heater 300 constituting the image heating apparatus 2, some members of the fixing film 202 and the like are shown as transparent while depiction of other members has been omitted in a similar manner to FIG. 3.

FIG. 4A is a diagram showing a state where the fixing film 202 is stationary. The fixing film 202 is stationary, and in a state where a force in the conveying direction D1 is not received from the recording material P, the fixing film 202 extends straight in the longitudinal direction (direction of the generatrix) without deformation.

FIG. 4B is a diagram showing the fixing film 202 rotating and being deflected by a deflection amount Lb. In FIG. 4B, an outer shape of the fixing film 202 before deformation (state of FIG. 4A) is depicted by a dotted line. The deflection amount Lb is an amount by which the central portion is deflected toward the downstream side in the conveying direction D1 from both longitudinal end portions regulated by the flange 315. In a case where subjected to a force from the recording material P, the fixing film 202 deflects in an arc so as to bulge toward the downstream side in the conveying direction D1. In this manner, the fixing film 202 may rotate during an image forming operation in a state where the longitudinal center portion is deflected toward the downstream side in the conveying direction D1.

A shape of the flange 315 that holds the guide ribs 320 and end portions of the fixing film 202 is designed such that, even in a case where a state where the fixing film 202 is deflected is taken into consideration, the inner surface of the fixing film 202 does not come into contact with the guide rib 320 even in a case where the flange 315 undergoes some degree of deformation. However, the shape of the flange 315 alone cannot completely prevent the fixing film 202 from coming into contact with the guide ribs 320, and, depending on image formation conditions and the like, the fixing film 202 may rub strongly against the guide ribs 320.

FIG. 4C is a diagram showing the fixing film 202 rotating, being deflected by a deflection amount Lc that is greater than the deflection amount Lb, and abutting against the guide ribs 320. In FIG. 4C, the outer shape of the fixing film 202 before deformation (state of FIG. 4A) is depicted by a dotted line. In a case where the fixing film 202 comes into contact with the guide ribs 320, the fixing film 202 loses heat to the guide ribs 320 through a contacting portion. This may cause a temperature variation along the longitudinal direction of the fixing film 202, potentially leading to poor fixing performance and reduced uniformity due to thermal non-uniformity. Furthermore, continued rotation of the fixing film 202 while in contact with the guide ribs 320 may also cause wear or a deformation of the inner surface of the fixing film 202.

Furthermore, the factors causing temperature non-uniformity or deformation in the fixing film 202 are not limited to those described above, and temperature non-uniformity may also occur due to an image pattern formed during an image forming operation. Next, examples where temperature non-uniformity or a deformation occurs due to an image patterns will be described.

Generally, the heater 300 of the image heating apparatus 200 provides uniform heat output along its length. The surface temperature of the fixing film 202 in contact with the recording material P during a fixing operation drops as heat is transferred to the recording material P. At this point, the amount by which the surface temperature drops differs depending on the presence or absence of a toner image. Since a portion with the toner image requires more heat to melt the toner, the amount of temperature drop increases.

A specific example of temperature non-uniformity and a deflection occurring in the fixing film 202 due to an image pattern will be described with reference to FIGS. 5A to 5C. In the present example, as image patterns, a pattern P1 in which character images cover the entire surface of the recording material P will be compared with a pattern P2 in which a toner image elongated in the conveying direction D1 is formed in both end portions of the recording material P in the width direction. FIG. 5A shows the pattern P2 in which a toner image elongated in the conveying direction D1 is formed in both end portions of the recording material P in the width direction.

FIG. 5B is a graph showing a surface temperature difference [° C.] of the fixing film 202 and a surface temperature difference [° C.] of the pressure roller 208 in a case where the recording material P for patterns P1 and P2 is fed consecutively and the image forming operation is performed a predetermined number of times. Here, a surface temperature difference refers to a difference in surface temperature between the end portions and the central portion in the longitudinal direction and is a value obtained by subtracting the surface temperature of the central portion from the surface temperature of the end portions. In other words, the surface temperature difference indicates how much lower the surface temperature at the longitudinal end portions is compared to the longitudinal center portion. FIG. 5B shows, from left to right, the surface temperature difference during printing of the pattern P1 on the fixing film 202, the surface temperature difference during printing of the pattern P2 on the fixing film 202, the surface temperature difference during printing of the pattern P1 on the pressure roller 208, and the surface temperature difference during printing of the pattern P2 on the pressure roller 208.

As shown in FIG. 5B, the surface temperature difference during printing of the pattern P1 on the fixing film 202 was approximately 0° C., the surface temperature difference during printing of the pattern P2 on the fixing film 202 was approximately −6° C., the surface temperature difference during printing of the pattern P1 on the pressure roller 208 was approximately 0° C., and the surface temperature difference during printing of the pattern P2 on the pressure roller 208 was approximately −4° C. As described above, the surface temperature differences of the fixing film 202 and the pressure roller 208 are larger in a case where printing the pattern P2 as compared to in a case where printing the pattern P1. In other words, in a case where images with toner images in the same position are printed consecutively, it may be seen that the drop in the surface temperature at the position of the toner image is greater compared to areas without a toner image.

An elastic layer 210 of the pressure roller 208 is formed of silicone rubber and expands according to temperature. Therefore, in a state where the temperature of both end portions of the pressure roller 208 has dropped, the central portion expands more than the end portions. As a result, the pressure roller 208 acquires a shape where the central portion is wider than the end portions.

FIG. 5C is a graph showing an outer diameter profile of the pressure roller 208 in which an outer diameter profile during printing of the pattern P1 is depicted by a dotted line and an outer diameter profile during printing of the pattern P2 is depicted by a solid line. An ordinate of the graph in FIG. 5C represents an outer diameter [mm] of the pressure roller 208 and an abscissa of the graph represents a position [mm] in the longitudinal direction of the pressure roller 208 (distance from one end in the longitudinal direction). As shown in FIG. 5C, the outer diameter of both end portions of the pressure roller 208 in the longitudinal direction is obviously smaller during printing of the pattern P2 as compared to during printing of the pattern P1.

Since a peripheral velocity of the central portion becomes higher than a peripheral velocity of the end portions in a case where the outer diameter of the central portion becomes larger than the outer diameter of the end portions, the central portion of the fixing film 202 that is driven to rotate so as to follow the pressure roller 208 also receives a force that causes the central portion to rotate faster than the end portions. In a case where subjected to such a force, the longitudinal center portion of the fixing film 202 deforms and may rub strongly against the guide ribs 320 as shown in FIG. 4C.

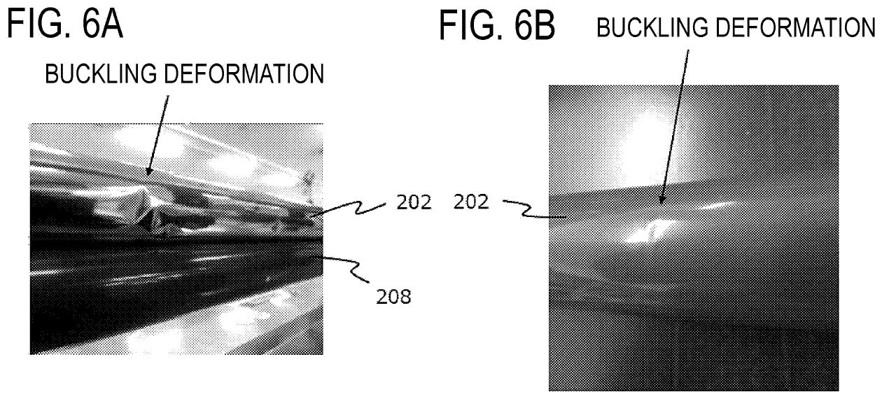

In a case where the fixing film 202 rubs strongly against the guide ribs 320, buckling deformation involving greater deflective deformation may occur between the guide ribs 320 aligned in the Y-direction. FIGS. 6A and 6B are diagrams showing an example of the fixing film 202 having undergone buckling deformation.

Buckling deformation will now be described in greater detail. Buckling deformation refers to a phenomenon where a load (deflecting force) applied to a structure (in one or more embodiments, the fixing film 202) increases, and the structure deforms significantly and undergoes a state change (a dynamic transition from reversible to irreversible change) in a case where the load exceeds a certain load value, resulting in substantial deflection.

The fixing film 202 is a thin-walled cylindrical structure formed from a high-performance resin such as polyimide or a metal such as stainless steel to achieve low thermal capacity, and a buckling strength thereof is not particularly high. While the fixing film 202 may conceivably be made thicker in order to increase buckling strength, a thick fixing film 202 is not suitable for the image heating apparatus 2 adopting a film heating system for the following reasons.

In a case where the material of the fixing film 202 is a metallic material such as stainless steel, increased thickness heightens the risk of crack failure due to repeated stress experienced while passing through the fixing nip N. In a case where the material of the fixing film 202 is a high-performance resin such as polyimide, thermal conductivity of the fixing film 202 decreases as its thickness increases. Therefore, increasing the thickness of the fixing film 202 does not significantly enhance buckling strength.

Alternatively, as the film guide 201 that prevents buckling deformation of the fixing film 202, for example, a configuration where a straight surface extending in the longitudinal direction regulates deformation of the fixing film 202 instead of providing guide ribs is also conceivable. In such a configuration, although buckling deformation no longer occurs due to the inner circumferential surface of the fixing film 202 coming into surface contact with the film guide 201, a greater amount of heat is dissipated by the film guide 201. As a result, more heaters 300 will be turned on to compensate for the lost heat, ultimately increasing power consumption and undermining energy efficiency. Furthermore, there is also concern that the frictional resistance acting on the fixing film 202 will increase.

In addition, the number of guide ribs 320 may conceivably be increased in order to suppress buckling deformation of the fixing film 202. However, as the fixing film 202 comes into contact with the guide ribs 320 more frequently, concerns about temperature non-uniformity in the fixing film 202 also increase. Therefore, excessively increasing the number of guide ribs 320 is also undesirable.

Next, the buckling deformation of the fixing film 202 will be described in greater detail. Buckling deformation is a phenomenon that occurs in a case where the fixing film 202 undergoes rotational movement. In consideration thereof, an industrial fiberscope was installed on an upstream side of the image heating apparatus 2 in the conveying direction D1 to observe the fixing film 202.

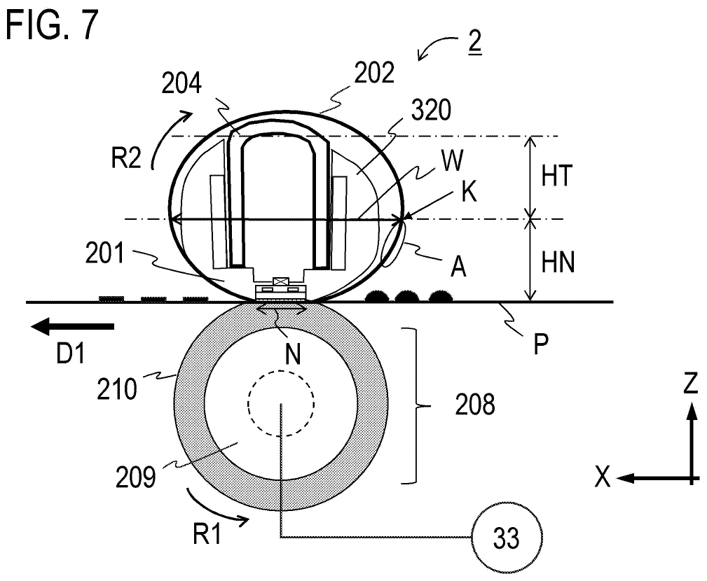

FIG. 7 is an explanatory diagram of an origin of buckling deformation of the fixing film 202. Buckling deformation occurs on an upstream side of the fixing nip N in the conveying direction D1, with the origin of buckling deformation being a vicinity of a position where the width of the fixing film 202 in the conveying direction D1 (X-direction) is maximum. FIG. 7 shows the position where the width of the fixing film 202 in the conveying direction D1 is at its maximum as an origin K. The origin K may also be described as an upstream end of the fixing film 202 in the conveying direction D1. The reason why buckling deformation occurs in the vicinity of the origin K is because the origin K is a transition point where a width W of the fixing film 202 changes from a portion where the width W widens toward the maximum width (the highest point of the fixing film 202 in the drawing) to a portion where the width W narrows.

Since the fixing film 202 is undergoing rotational movement at the instant buckling deformation occurs, the buckling deformation occurring in the vicinity of the origin K appears as though occurring in an area indicated as an area A in FIG. 7 being an area on a downstream side of the origin K in an R2 direction being a rotation direction of the fixing film 202. In a case where a state of constant buckling deformation occurs, the width of the fixing film 202 in the conveying direction D1 is observed to be deforming around the origin K where the width is at its maximum width W. The fixing film 202 having undergone buckling deformation in this manner rotationally moves and enters the fixing nip N while maintaining the state of buckling deformation.

Buckling deformation may be resolved in a case where the deformed portion enters the fixing nip N, as the rotational trajectory of the fixing film 202 is constrained within the fixing nip N. However, repeated entry into the fixing nip N while in a state of buckling deformation may cause the fixing film 202 to undergo plastic deformation, potentially leaving traces of buckling deformation on the fixing film 202. In a case where the toner image is fixed onto the fixing film 202 bearing buckling deformation marks, those marks are also transferred onto the recording material P. Furthermore, continued use in such a state may cause the fixing film 202 to crack and break starting at the buckled deformation area.

As the fixing film 202 continues to rotate, buckling deformation spreads not only in the area A but also toward the upstream side in the rotational direction (R2 direction) around the origin K. A range where buckling deformation occurs on the upstream side of the origin K of the fixing film 202 in the rotation direction is a range of approximately a distance HT from the origin K in the Z-direction (see FIG. 7). Here, the distance HT is a same distance as a distance HN from the fixing nip N to the origin K in the Z-direction.

### 4. Detailed Configuration(s) of One or More Embodiments of a Film Guide

In one or more embodiments, a sub-guide rib 330 is provided on the film guide 201 as a component to suppress buckling deformation of the fixing film 202. Hereinafter, detailed configuration(s) of the film guide 201 according to one or more embodiments will be described.

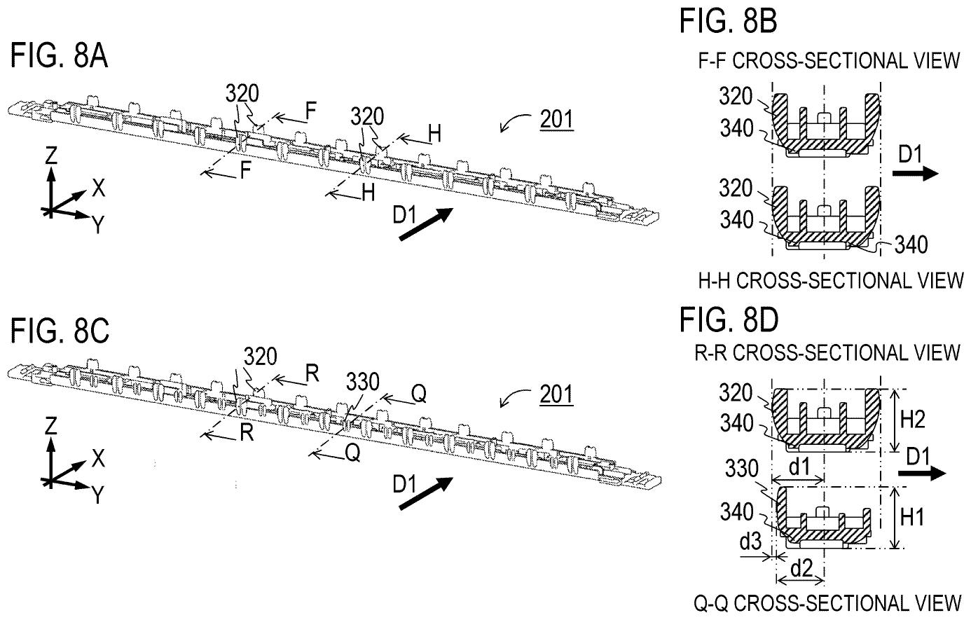

FIGS. 8A to 8D are explanatory diagrams of two or more embodiments of film guides 201 according to one or more aspects of the present disclosure. FIG. 8A is a perspective view of a film guide 201 according to a comparative embodiment of the two or more embodiments. FIG. 8B is a combined diagram showing a sectional view taken along F-F and a sectional view taken along H-H in FIG. 8A. The F-F cross section and the H-H cross section are both cross sections that pass through the guide ribs 320 in a case where the film guide 201 is viewed in the longitudinal direction.

In the comparative embodiment, the guide ribs 320 are provided in plurality (13 in the illustrated example) so as to be aligned on an upstream side and a downstream side in the conveying direction D1. All of the plurality of guide ribs 320 have the same shape, and a cross-sectional shape of the film guide 201 in the F-F cross section and the H-H cross section is identical. In such a configuration, as described above, buckling deformation of the fixing film 202 may occur between guide ribs 320 that are adjacent to each other in the longitudinal direction.

In consideration thereof, one or more embodiments may adopt, in addition to the guide ribs 320, a configuration in which a plurality of sub-guide ribs 330 for regulating the rotational shape of the fixing film 202 and suppressing buckling deformation are provided in the film guide 201. FIG. 8C is a perspective view of the one or more embodiments of a film guide 201 that may include the sub-guide ribs 330. FIG. 8D is a combined diagram showing a sectional view taken along R-R and a sectional view taken along Q-Q in FIG. 8C. The R-R cross section is a cross section that passes through the guide ribs 320 in a case where the film guide 201 is viewed in the longitudinal direction, and the Q-Q cross section is a cross section that passes through the sub-guide ribs 330 in a case where the film guide 201 is viewed in the longitudinal direction.

The film guide 201 includes a heater holding portion 340 that holds the heater 300, and a plurality of guide ribs 320 and a plurality of sub-guide ribs 330 that regulate the rotational shape of the fixing film 202. In other words, the film guide 201 is provided with two types of regulating portions, namely, the guide ribs 320 as a first regulating portion and the sub-guide ribs 330 as a second regulating portion. The guide ribs 320 are provided on both the upstream and downstream sides relative to the heater holding portion 340 and the fixing nip N in the conveying direction D1, whereas the sub-guide ribs 330 are provided only on the upstream side relative to the heater holding portion 340 and the fixing nip N in the conveying direction D1.

The sub-guide ribs 330 are protruded portions that protrude toward the upstream side relative to the fixing nip N in the conveying direction D1 and are regulating portions that regulate the rotational shape of the fixing film 202. The sub-guide ribs 330 are provided between two guide ribs 320 in the longitudinal direction of the film guide 201. In addition, the amount of protrusion of the sub-guide ribs 330 toward the upstream side in the conveying direction D1 differs from the amount of protrusion of the guide ribs 320 toward the upstream side in the conveying direction D1. In other words, as shown in FIG. 8C, the guide ribs 320 and the sub-guide ribs 330 with different amounts of protrusion are alternately arranged in the Y-direction on the upstream side of the film guide 201 in the conveying direction D1. In one or more embodiments, the plurality of sub-guide ribs 330 are arranged so that one or more sub-guide ribs 330 are adjacent in the Y-direction with respect to all of the guide ribs 320 provided on the upstream side in the conveying direction D1.

The sub-guide ribs 330 are formed with a curved shape that protrudes toward the upstream side in the conveying direction D1 in a similar manner to the guide ribs 320. This shape prevents angular contact with the inner circumferential surface of the fixing film 202, thereby suppressing the risk of impeding the rotation of the fixing film 202 or damaging the fixing film 202. In addition, the sub-guide ribs 330 are configured so that the amount of protrusion in the conveying direction D1 is smaller than that of the guide ribs 320. Note that the amounts of protrusion of the guide ribs 320 and the sub-guide ribs 330 may be defined as, for example, a distance from a center of the heater 300 to an upstream end of a rib in the conveying direction D1. However, the reference position for the amounts of protrusion is not limited to the center of the heater 300 and may also be, for example, the upstream end of the fixing nip N. In other words, the upstream end of the sub-guide ribs 330 is positioned on a downstream side relative to the upstream end of the guide ribs 320 in the conveying direction D1.

As described above, the film guide 201 according to one or more embodiments is provided with ribs of two different sizes and amounts of protrusion in the conveying direction D1 and the opposite direction. Adopting such a configuration ensures that even in a case where the fixing film 202 is deflected and comes into contact with the guide ribs 320 and attempts to deform further, the fixing film 202 will come into contact with the sub-guide ribs 330 and deformation of the fixing film 202 is suppressed. Therefore, the fixing film 202 may be prevented from reaching buckling deformation. In addition, since the sub-guide ribs 330 are positioned on the downstream side of the guide ribs 320 in the conveying direction D1, in a case where the deformation of the fixing film 202 is not large, the fixing film 202 only abuts against the guide ribs 320 without coming into contact with the sub-guide ribs 330. Therefore, a situation where the sub-guide ribs 330 dissipate the heat of the fixing film 202 and thermal non-uniformity occurs in the fixing film 202 may also be suppressed.

Since buckling deformation of the fixing film 202 mainly occurs on the upstream side of the fixing nip N in the conveying direction D1, in one or more embodiments, the sub-guide ribs 330 are not provided on the downstream side in the conveying direction D1 and are only provided on the upstream side in the conveying direction D1.

Next, a detailed configuration of the sub-guide ribs 330 will be described. As described above, positions of upstream ends of the guide ribs 320 in the conveying direction D1 and the sub-guide ribs 330 differ from each other. As shown in FIG. 8D, in the conveying direction D1, let a distance from the center of the heater 300 to the upstream end of the guide ribs 320 be defined as a distance d1 and a distance from the center of the heater 300 to the upstream end of the sub-guide ribs 330 be defined as a distance d2. Note that the distance d1 may also be described as the amount of protrusion of the guide ribs 320 and the distance d2 may also be described as the amount of protrusion of the sub-guide ribs 330. In one or more embodiments, the distance d2 is shorter than the distance d1. In this case, a distance d3 from the upstream end of the sub-guide ribs 330 to the upstream end of the guide ribs 320 in the conveying direction D1 is equal to d1−d2. The distance d3 corresponds to a difference in the amounts of protrusion of the guide ribs 320 and the sub-guide ribs 330.

In a case where the distance d3 is long or, in other words, in a case where the amount of protrusion of the sub-guide ribs 330 is small, an effect of suppressing buckling deformation decreases. On the other hand, while an effect of suppressing buckling deformation increases in a case where the distance d3 is short or, in other words, in a case where the amount of protrusion of the sub-guide ribs 330 is large, as the fixing film 202 comes into contact with the sub-guide ribs 330 more frequently, concerns about image defects such as vertical streaks caused by thermal non-uniformity also increase. In order to suppress buckling deformation while suppressing the occurrence of image defects, the distance d2 being the amount of protrusion of the sub-guide ribs 330 relative to the distance d1 being the amount of protrusion of the guide ribs 320 is preferably a value within a range of 5 to 20% less than the distance d1. In other words, the distance d2 is preferably within a range of 80% to 95% of the distance d1. In addition, the distance d3 is preferably within a range of 0.5 mm to 2.0 mm.

Next, lengths (heights) of the guide ribs 320 and the sub-guide ribs 330 in the Z-direction (direction orthogonal to the fixing nip N) will be described. As shown in FIG. 7, in a case where viewed on a cross section perpendicular to the direction of the generatrix of the fixing film 202, the origin K of buckling deformation is at a position where the width of the fixing film 202 in the conveying direction D1 is a maximum width W or a vicinity thereof. Therefore, in order to more effectively suppress buckling deformation, the sub-guide ribs 330 are preferably formed so as to extend in the Z-direction up to the origin K or the area A in the vicinity of the origin K.

In one or more embodiments, the sub-guide ribs 330 are configured so that a distance H1 from the fixing nip N to a distal end of the sub-guide ribs 330 in the Z axis direction is longer than a distance HN (a distance from the fixing nip N to the origin K in the Z-direction). In other words, the sub-guide ribs 330 are formed so as to extend to a position that surpasses the origin K in the Z-direction. Such a configuration enables deformation of the fixing film 202 to be suppressed by the sub-guide ribs 330 at the origin K or a vicinity thereof. Note that in one or more embodiments, the guide ribs 320 are also formed so as to extend to a position that surpasses the origin K in the Z-direction in a similar manner to the sub-guide ribs 330. In other words, a distance H2 from the fixing nip N to a distal end of the guide ribs 320 in the Z axis direction is longer than the distance HN.

The distance d3 that corresponds to the difference in the amounts of protrusion of the sub-guide ribs 330 and the guide ribs 320, the distance H1 that corresponds to the height of the sub-guide ribs 330, and the like are not limited to the ranges described above. Each may vary depending on the specifications of the image heating apparatus 2, the outer diameter of the fixing film 202, the design of the film guide 201, and the like in one or more embodiments.

Next, an evaluation test conducted to evaluate a suppression effect of buckling deformation achieved by the above configuration of one or more embodiments will be described. In the evaluation test, similar paper-passing tests were performed using respective film guides 201 according to the comparative embodiment and one or more embodiments using sub-guide ribs 330 shown in FIGS. 8A and 8C, respectively. In the evaluation test, the pattern P2 shown in FIG. 5A was continuously printed, and the presence or absence of buckling deformation in the fixing film 202 and the presence or absence of transfer of buckling deformation marks to the recording material P were confirmed. Buckling deformation marks were confirmed by passing a full-page halftone once every ten sheets of the pattern P2 were printed.

The presence or absence of buckling deformation was confirmed using an industrial fiberscope installed on the upstream side of the image heating apparatus 2 in the conveying direction D1. Results of the evaluation test are shown in Table 1. In Table 1, the state of the fixing film 202 at a prescribed number of passed sheets is indicated by symbols. Ranks indicated by the symbols in Table 1 below are as follows: “A” denotes a state where the fixing film 202 is rotating without deformation. “B” denotes a state where rotational movement occurs with minor buckling deformation, but no issues are present. “C” denotes a state where rotational movement occurs while buckling deformation comparable to that shown in FIG. 6 may be recognized. “D” denotes a state where a buckling deformation mark may be recognized in the full-page halftone image.

TABLE 1

| Number of passed | Comparative | Embodiment using |
|---|---|---|
| sheets | embodiment | sub-guides 330 |
| 1 | A | A |
| 5 | A | A |
| 10 | A | A |
| 15 | B | B |
| 20 | B | B |
| 25 | C | B |
| 30 | C | B |
| 40 | D | B |
| 50 | D | B |

In the comparative embodiment, the fixing film 202 showed no deformation up to 10 sheets of paper passed, but at 15 and 20 sheets of paper passed, minor buckling deformation was observed, which was deemed acceptable. However, at 25 and 30 sheets of paper passed, buckling deformation was clearly recognizable, raising concerns about continuing to use the fixing film 202 as it is. In addition, at 40 sheets of paper passed, buckling deformation marks became recognizable across the full-page halftone image.

On the other hand, in one or more embodiments using the sub-guide ribs 330, the fixing film 202 showed no deformation up to 10 sheets of paper passed, but at 15 sheets of paper passed, minor buckling deformation was observed, which was deemed acceptable. In addition, even at 50 sheets of paper passed, the buckling deformation occurring in the fixing film 202 was only minor and within acceptable limits. Furthermore, no buckling deformation marks were recognized in the full-page halftone image.

Based on the above, the present evaluation test revealed that the configuration of the one or more embodiments using the sub-guides 330 may suppress buckling deformation of the fixing film 202 compared to the configuration of the comparative embodiment. In other words, it was revealed that providing the sub-guide ribs 330 produces a suppression effect of buckling deformation of the fixing film 202.

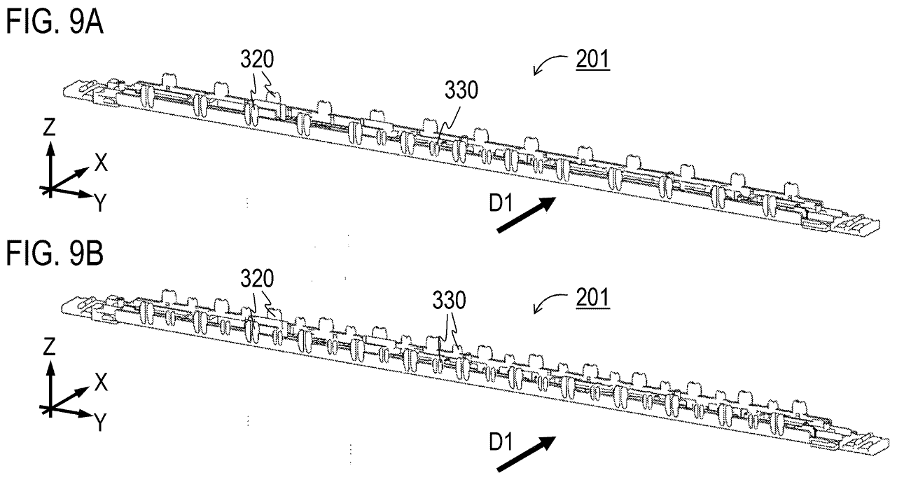

Next, film guides 201 with configurations that differ from that of the one or more embodiments will be described as modifications of the aforementioned one or more embodiments. FIGS. 9A and 9B are explanatory diagrams of the film guides 201 that may be used in one or more embodiments according to the modifications. Which configuration is to be adopted by the aforementioned one or more embodiments and the modifications is desirably selected according to the specifications and modes of the image forming apparatus 1 and the image heating apparatus 2.

### Arrangement Position of Sub-Guide Ribs in Longitudinal Direction of Film Guide in One or More Embodiments or in One or More Additional Embodiments

First, as a first modification that may be used in one or more additional embodiments, a configuration where the arrangement position of the sub-guide ribs 330 in the Y-direction differs from the aforementioned one or more embodiments will be described. FIG. 9A is a perspective view of the film guide 201 according to the first modification that may be used in one or more embodiments or in one or more additional embodiments.

While the sub-guide ribs 330 were also arranged at both end portions of the film guide 201 in the longitudinal direction in the aforementioned one or more embodiments, in the first modification that may be used in one or more embodiments or in one or more additional embodiments, the sub-guide ribs 330 are only arranged in the central portion of the film guide 201 in the longitudinal direction. Here, the central portion of the film guide 201 in the longitudinal direction refers to an area in a vicinity of a longitudinal center. In the illustrated example, four sub-guide ribs 330 are provided in the central portion of the film guide 201 in the longitudinal direction.

Buckling deformation of the fixing film 202 occurs in the central portion in the longitudinal direction. In consideration thereof, even a configuration where the sub-guide ribs 330 are only installed in the central portion and only the guide ribs 320 are provided in both end portions, a suppression effect of buckling deformation is produced as compared to the comparative embodiment.

### Arrangement Position of Sub-Guide Ribs in Conveying Direction for One or More Embodiments or for One or More Additional Embodiments

Next, as a second modification that may be used in one or more embodiments or in one or more additional embodiments, a configuration where the arrangement position of the sub-guide ribs 330 in the Z-direction differs from the aforementioned one or more embodiments will be described. FIG. 9B is a perspective view of the film guide 201 according to the second modification.

While the sub-guide ribs 330 were only arranged on the upstream side of the film guide 201 in the conveying direction D1 in the aforementioned one or more embodiments, in the second modification, the sub-guide ribs 330 are also arranged on the downstream side of the film guide 201 in the conveying direction D1. In other words, in the second modification that may be used in the one or more embodiments or in one or more additional embodiments, the regulating portions of the film guide 201 are arranged symmetrically with respect to a centerline of the conveying direction D1.

In one or more embodiments, the guide ribs 320 arranged on the upstream side in the conveying direction D1 of the film guide 201 may be designated as a first regulating portion, the sub-guide ribs 330 arranged on the upstream side in the conveying direction D1 of the film guide 201 may be designated as a second regulating portion, the guide ribs 320 arranged on the downstream side in the conveying direction D1 of the film guide 201 may be designated as a third regulating portion, and the sub-guide ribs 330 arranged on the downstream side in the conveying direction D1 of the film guide 201 may be designated as a fourth regulating portion. In this case, the third regulating portion and the fourth regulating portion protrude toward the downstream side in the conveying direction D1 with respect to the fixing nip N, respectively. In addition, in the conveying direction D1, each regulating portion is configured such that a downstream end of the fourth regulating portion is positioned on an upstream side relative to a downstream end of the third regulating portion. Furthermore, a height of the third regulating portion in the Z-direction is similar to that of the first regulating portion and a height of the fourth regulating portion in the Z-direction is similar to that of the second regulating portion.

In one or more embodiments or in one or more additional embodiments, the resin-molded film guide 201 is a component using or employing high dimensional accuracy along its entire length, including surface accuracy of a surface for installing the metal stay that holds the fixing film 202 and the heater 300 and ensures structural strength. In consideration thereof, providing the sub-guide ribs 330 on the downstream side in the conveying direction D1 ensures uniformity of resin flow during the molding of the film guide 201 and produces high dimensional accuracy. From such a perspective, in the conveying direction D1, the upstream-side sub-guide ribs 330 and the downstream-side sub-guide ribs 330 are preferably configured with left-right symmetrical shapes with respect to the centerline of the film guide 201.

### Maximum Supported Width of Recording Material

Next, as a third modification that may be used in one or more embodiments or in one or more additional embodiments, a configuration where the position (amount of protrusion) of the upstream end of the sub-guide ribs 330 in the conveying direction D1 is varied will be described.

While the image forming apparatus 1 that supports LTR/A4 sizes as a maximum paper-passing width of the recording material P has been described in the aforementioned one or more embodiments, in a case where A3/LDR sizes are to be supported as the maximum paper-passing width, an increased total length of the fixing film 202 also increases the amount of deflection toward the downstream side. In consideration thereof, in the third modification that may be used, the rib configuration with two levels of the amount of protrusion is modified to a rib configuration with three or more levels of the amount of protrusion, following the deflection of the fixing film 202.

The third modification adopts a configuration where the distance d3 that is the difference in the amounts of protrusion between the sub-guide ribs 330 and the guide ribs 320 in the longitudinal center portion is shorter than the distance d3 that is the difference in the amounts of protrusion between the sub-guide ribs 330 and the guide ribs 320 in the longitudinal end portions. Adopting such a configuration enhances the suppression effect of buckling deformation at the longitudinal center portion where the sub-guide ribs 330 experience greater deflection of the fixing film 202, while reducing the opportunities for the sub-guide ribs 330 to come into contact with the fixing film 202 in the longitudinal end portions where deflection is smaller. At this point, the distance d3 may be configured to decrease continuously or in stages from, for example, the longitudinal center portion toward the longitudinal end portions.

While the guide ribs 320 and the sub-guide ribs 330 are integrally formed with respect to the film guide 201 in the aforementioned one or more embodiments and the respective modifications that may be used in one or more embodiments or in one or more additional embodiments, the configuration of the guide ribs 320 and the sub-guide ribs 330 is not limited thereto. For example, each rib may be configured to be attachable/detachable with respect to the film guide 201 or a regulating member (guiding member) including each rib may be configured as a separate body from a heater holding member that includes the heater holding portion 340.

Based on the above, according to the configurations of the aforementioned one or more embodiments and the modifications, even in a case where the fixing film 202 deflects significantly toward the downstream side in the conveying direction D1, the sub-guide ribs 330 suppress a deflection of the fixing film 202, thereby preventing buckling deformation attributable to the deflection. Furthermore, since the contact area of the fixing film 202 with respect to the film guide 201 may be minimized, dissipation of heat of the fixing film 202 by the film guide 201 may be suppressed and power consumption may be reduced.

### Configuration(s) of One or More Further Embodiments

Next, one or more further embodiments according to the present disclosure will be described. The one or more further embodiments differ from the aforementioned one or more embodiments in the configuration of the film guide 201. Hereafter, only points of the configuration of the one or more further embodiments that differ from the configuration of the aforementioned one or more embodiments will be described. Among the components of the one or more further embodiments, components similar to those of the aforementioned one or more embodiments will be denoted by the same reference signs and descriptions thereof will not be repeated.

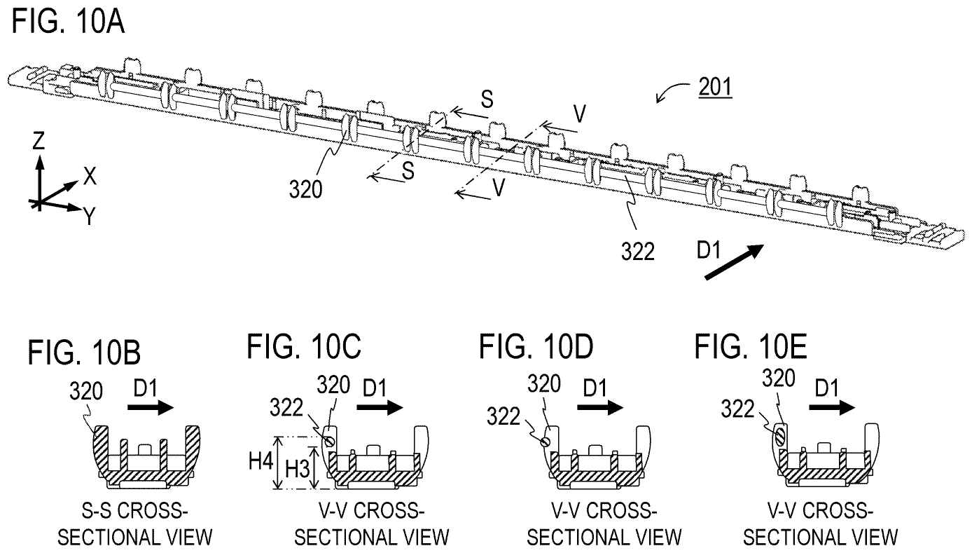

FIGS. 10A to 10E are explanatory diagrams of the film guide 201 according to the one or more further embodiments. FIG. 10A is a perspective view of the film guide 201 according to the one or more further embodiments. FIG. 10B is a cross section along S-S in FIG. 10A. FIG. 10C is a cross section along V-V in FIG. 10A.

The one or more further embodiments represent a configuration provided with a plurality of bridge members 322 as a regulating portion in place of the sub-guide ribs 330. The bridge members 322 are regulating portions extending along the direction of the generatrix (Y-direction) of the fixing film 202 from one guide rib 320 to the adjacent guide rib 320 so as to bridge between the guide ribs 320 of the film guide 201. The plurality of bridge members 322 are all provided on the upstream side of the film guide 201 in the conveying direction D1. In other words, it may be said that the film guide 201 according to the one or more further embodiments is provided with the guide ribs 320 as a first regulating portion and the bridge members 322 as a second regulating portion.

A cross-sectional shape of the bridge members 322 in a direction orthogonal to the longitudinal direction (Y-direction) is a circle in one or more embodiments. Conceivably, the bridge members 322 may be integrally formed with the film guide 201 or the bridge members 322 may be configured as separate members to be mounted to the guide ribs 320. The S-S cross section is a cross section that passes through the guide ribs 320 when the film guide 201 is viewed in the longitudinal direction, and the V-V cross section is a cross section that passes through the bridge members 322 when the film guide 201 is viewed in the longitudinal direction.

According to this configuration, in the longitudinal direction of the film guide 201, the bridge members 322 may be brought into contact with the fixing film 202 over substantially the entire area between the guide ribs 320. Therefore, according to the configuration of the one or more further embodiments, an occurrence of thermal non-uniformity in the longitudinal direction of the fixing film 202 may be suppressed as compared to the configuration(s) of one or more of the aforementioned one or more embodiments.

Next, a position where the bridge members 322 are provided will be described. The bridge members 322 are preferably arranged in consideration of the origin K of buckling deformation (a point where the width of the fixing film 202 in the conveying direction D1 is maximized) in a similar manner to the aforementioned one or more embodiments. In consideration thereof, the bridge members 322 are arranged in the Z-direction at a same position as the origin K (the upstream end of the fixing film 202 in the conveying direction D1) with at least a portion overlapping within the area A. In other words, in a case where a distance from the fixing nip N to an end of the bridge members 322 that is closer to the fixing nip N in the Z-direction is denoted by H3, the distance H3 is shorter than the distance HN. In addition, in a case where a distance from the fixing nip N to an end of the bridge members 322 that is farther from the fixing nip N in the Z-direction is denoted by H4, the distance H4 is longer than the distance HN. Adopting such a configuration enables the suppression effect of buckling deformation to be enhanced.

In the one or more further embodiments, as shown in FIG. 10C, the position of the upstream end of the bridge members 322 is positioned on a downstream side relative to the upstream end of the guide ribs 320 in the conveying direction D1. In other words, the bridge members 322 are provided at a position that is recessed toward the downstream side relative to the guide ribs 320 in the conveying direction D1. However, the configuration of the bridge members 322 is not limited thereto.

For example, the upstream end of the bridge members 322 may be positioned on an upstream side relative to the upstream end of the guide ribs 320 in the conveying direction D1. In other words, the bridge members 322 may be provided at a position that protrudes toward the upstream side relative to the guide ribs 320 in the conveying direction D1. Compared to the aforementioned one or more embodiments, the configuration of the one or more further embodiments features a longer longitudinal distance of a contact portion where the deflected fixing film 202 comes into contact with the regulating portion, making the configuration less prone to partial thermal non-uniformity in the longitudinal direction. FIG. 10D is a V-V sectional view showing an example of a configuration in which the bridge members 322 protrude toward the upstream side relative to the guide ribs 320 in the conveying direction D1.

In addition, the cross-sectional shape of the bridge members 322 in the direction orthogonal to the Y-direction may be an ellipse (or ovular) instead of a circle. FIG. 10E is a V-V sectional view showing an example where the cross-sectional shape of the bridge members 322 is an ellipse (or ovular). In the present example, the cross-sectional shape of the bridge members 322 is an ellipse of which a longitudinal direction is the Z-direction and a transverse direction is the X-direction. The cross-sectional shape of the bridge member 322 should preferably have a smooth surface with which the inner surface of the deflected fixing film 202 comes into contact, and a cross-section that comes into contact with the fixing film 202 at an angle is undesirable. In other words, the surface of the bridge members 322 that opposes the inner circumferential surface of the fixing film 202 is preferably a curved surface that is convex toward the upstream side in the conveying direction D1.

In addition, while the one or more further embodiments adopt a configuration in which the bridge members 322 are provided between all of the guide ribs 320, the bridge members 322 are not limited to this configuration. For example, a configuration may be adopted in which the bridge members 322 are only provided in the central portion and not provided in the end portions of the film guide 201 in the longitudinal direction in a similar manner to the one or more embodiments described earlier. Furthermore, a configuration where the arrangement positions and cross-sectional shapes of the bridge members 332 are varied in the longitudinal direction is also conceivable.

Based on the above, according to the subject configuration of the one or more further embodiments, even in a case where the fixing film 202 deflects significantly toward the downstream side in the conveying direction D1, the bridge members 322 as a regulating portion suppress a deflection of the fixing film 202, thereby preventing buckling deformation attributable to the deflection.

A detailed configuration of the bridge members 322 is desirably optimized according to the specifications of the image heating apparatus 2 and modes of the fixing film 202 and the film guide 201 in a similar manner to the aforementioned one or more embodiments. Even in the configuration provided with the bridge members 322 as described above, an effect of suppressing buckling deformation of the fixing film 202 may be produced in a similar manner to the one or more embodiments described earlier.

According to the present disclosure, an image heating apparatus capable of suppressing film deformation may be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021654, filed Feb. 13, 2025, which is hereby incorporated by reference herein in its entirety.

What is claimed is:

1. An image heating apparatus configured to heat an image formed on a recording material while conveying the recording material with a nip portion, the image heating apparatus comprising:
a rotatable cylindrical film;
a heater configured to heat the rotatable cylindrical film, the heater being arranged in an internal space of the rotatable cylindrical film;
a roller which comes into contact with an outer circumferential surface of the rotatable cylindrical film and which forms the nip portion for conveying the recording material in a conveying direction between the roller and the rotatable cylindrical film; and
a regulating member which is arranged in the internal space of the rotatable cylindrical film and configured to regulate a rotational shape of the rotatable cylindrical film, the regulating member including a plurality of first regulating portions arrayed along a direction of a generatrix of the rotatable cylindrical film on an upstream side in the conveying direction with respect to the nip portion and a second regulating portion arranged between the plurality of first regulating portions in the direction of the generatrix of the rotatable cylindrical film, wherein
in the conveying direction, an upstream end of the second regulating portion is positioned on a downstream side of an upstream end of the first regulating portions, and in a direction orthogonal to the conveying direction and to the direction of the generatrix of the rotatable cylindrical film, a distance from the nip portion to a distal end of the second regulating portion is longer than a distance from the nip portion to an upstream end of the rotatable cylindrical film in the conveying direction.

2. The image heating apparatus according to claim 1, wherein
the regulating member includes the second regulating portion in plurality, and
the plurality of the first regulating portions and the plurality of the second regulating portions are alternately arranged in the direction of the generatrix of the rotatable cylindrical film.

3. The image heating apparatus according to claim 2, wherein
one or more second regulating portions of the plurality of the second regulating portions are provided adjacent in the direction of the generatrix of the rotatable cylindrical film with respect to all of the first regulating portions among the plurality of the first regulating portions.

4. The image heating apparatus according to claim 1, wherein
the second regulating portion is only provided in a central portion of the regulating member in the direction of the generatrix of the rotatable cylindrical film.

5. The image heating apparatus according to claim 1, wherein
the regulating member includes a plurality of third regulating portions which are arrayed along the direction of the generatrix of the of the rotatable cylindrical film on a downstream side in the conveying direction with respect to the nip portion and a fourth regulating portion arranged between the plurality of the third regulating portions in the direction of the generatrix of the rotatable cylindrical film,
in the conveying direction, an upstream end of the fourth regulating portion is positioned on an upstream side of a downstream end of the third regulating portions, and
in the direction of the generatrix of the rotatable cylindrical film and a direction orthogonal to the conveying direction, a distance from the nip portion to a distal end of the fourth regulating portion is longer than a distance from the nip portion to an upstream end of the film in the conveying direction.

6. The image heating apparatus according to claim 2, wherein
in the conveying direction, a distance from an upstream end of the second regulating portions provided in a central portion of the regulating member in the direction of the generatrix of the rotatable cylindrical film to an upstream end of the first regulating portions is shorter than a distance from an upstream end of the second regulating portions provided in end portions of the regulating member in the direction of the generatrix of the rotatable cylindrical film to an upstream end of the first regulating portions.

7. The image heating apparatus according to claim 1, wherein
in the conveying direction, a distance from a center of the heater to an upstream end of the second regulating portion is within a range of 80% to 95% of a distance from the center of the heater to an upstream end of the first regulating portions.

8. The image heating apparatus according to claim 1, wherein
in the conveying direction, a distance from an upstream end of the second regulating portion to an upstream end of the first regulating portions is within a range of 0.5 mm to 2.0 mm.

9. The image heating apparatus according to claim 1, wherein
the second regulating portion is formed in a curved shape that is convex toward an upstream side in the conveying direction.

10. The image heating apparatus according to claim 1, wherein
the regulating member is a heater holding member which holds the heater.

11. The image heating apparatus according to claim 1, wherein
the rotatable cylindrical film is formed of a heat-resistant resin or metal.

12. An image heating apparatus configured to heat an image formed on a recording material while conveying the recording material with a nip portion, the image heating apparatus comprising:
a rotatable cylindrical film;
a heater configured to heat the rotatable cylindrical film, the heater being arranged in an internal space of the rotatable cylindrical film;
a roller which comes into contact with an outer circumferential surface of the rotatable cylindrical film and which forms a nip portion for conveying the recording material in a conveying direction between the roller and the rotatable cylindrical film; and
a regulating member which is arranged in the internal space of the rotatable cylindrical film and configured to regulate a rotational shape of the rotatable cylindrical film, the regulating member including a plurality of first regulating portions arrayed along a direction of the generatrix of the rotatable cylindrical film on an upstream side in the conveying direction with respect to the nip portion and a second regulating portion extending along the direction of the generatrix of the rotatable cylindrical film from one of the first regulating portions to an adjacent first regulating portion among the plurality of first regulating portions, wherein
in a direction orthogonal to the conveying direction and to the direction of the generatrix of the rotatable cylindrical film, the second regulating portion is provided at a same position as an upstream end of the film in the conveying direction.

13. The image heating apparatus according to claim 12, wherein
the second regulating portion is provided in a central portion of the regulating member in the direction of the generatrix of the rotatable cylindrical film.

14. The image heating apparatus according to claim 12, wherein
the second regulating portion is provided across all of the plurality of first regulating portions.

15. The image heating apparatus according to claim 12, wherein
a surface of the second regulating portion opposing an inner circumferential surface of the rotatable cylindrical film is a curved surface that is convex toward an upstream side in the conveying direction.

16. The image heating apparatus according to claim 12, wherein
the regulating member is a heater holding member which holds the heater.

17. The image heating apparatus according to claim 12, wherein
the rotatable cylindrical film is formed of a heat-resistant resin or metal.
